(19) United States
(12) Patent Application Publication
(10) Pub. No.: US 2004/0139053 A1
(43) Pub. Date: Jul. 15, 2004

(54) Online regulatory compliance system and method for facilitating compliance

(76) Inventor: Gregory D. Haunschild, Katy, TX (US)

Correspondence Address: Jo Katherine D'Ambrosio, D'Ambrosio & Associates, Suite 465, 10260 Westheimer Road, Houston, TX, 77042, US

(21) Appl. No.: 10/744,497

(22) Filed: Dec. 23, 2003

Related U.S. Application Data
(63) Continuation-in-part of application No. 10/337,681, filed on Jan. 7, 2003.
Application No. 10/337,681 is a continuation-in-part of application No. 10/145,490, filed on May 14, 2002.
(60) Provisional application No. 60/345,238, filed on Jan. 4, 2002.

(51) Int. Cl. G06F 7/00

(52) U.S. Cl. 707/1

(57) ABSTRACT

A method and system for perpetually auditing compliance with rules and regulations emanating from government and other regulatory agencies comprising the steps of providing a secured, interactive web site system hosted by at least one computer server, accessibility to the web-based system limited to authorized users. Subject items specific for an authorized user are identified. The subject items preferably comprise facility sites, equipment located at the facility sites and operational activities occurring on the sites, the facility sites, equipment and operational activities being subject to regulatory compliance. Rgulatory compliance requirements that are applicable for substantially each identified subject item are then determined. The regulatory compliance requirements are continuously updated for the identified subject items and the status of each of the identified subject items is periodically checked to determine applicability of the regulations. Compliance requirements reports are provided to one or more persons responsible for compliance. To ensure compliance by company personnel, repeated reminders are generated to one or more persons responsible for accomplishing compliance.

### CROSS REFERENCES TO RELATED CASES

This is a continuation-in-part of U.S. patent application Ser. No. 10/337,681, filed Jan. 7, 2003, based upon U.S. patent application Ser. No. 10/145,490, filed May 14, 2002, abandoned, taking priority from U.S. Patent Application 60/345,238 filed Jan. 4, 2002, abandoned.

### FIELD OF INVENTION

The present invention relates to a regulatory compliance system and a method and system for perpetual compliance auditing. Particularly, the invention is directed to a web-based system of auditing compliance with rules and regulations for industries subject to federal, state and local agencies, industry association standards and company policies.

### BACKGROUND

A myriad of ever-changing rules and regulations apply to most businesses and organizations, especially those that affect the environment or public safety. Many of the rules and regulations may be statutory when emanating from federal, state and local governments. Rules also emanate from industry organizations, such as the American Petroleum Institute (hereinafter, API), as well as a company's own policies and procedures. Automated systems of integrated computer programs for facilitating compliance with government rules and regulations are available for various government and industry organizations. Generally, pertinent references in this field relate to one of three categories: 1) systems for managing compliance with regulatory entities and/or equipment, 2) systems and methods for determining compliance with government regulations for chemical products and 3) tracking systems to determine compliance requirements for hazardous materials as part of an overall management system.

In U.S. Pat. No. 6,292,806, Sandifer discloses a computer based maintenance and repair information system for equipment subject to regulatory compliance, specifically for aircraft. The technical database comprises electronically stored publications and maintenance information for aircraft and components. The status of compliance with Airworthiness Directives and manufacturer service information is maintained for each component, allowing users to determine whether or not an aircraft is in compliance with airworthiness regulations. In the '806 patent, the maintenance and repair information may be on different CD-ROM discs and there is no electronic commingling of publications, see Col. 22, lines 5-14. Each publication must be individually searched for data regarding a specific component. See Col. 31, lines, 44-60.

The next group of disclosed patents relate to systems for compliance of chemical products. Petke et al. in U.S. Pat. No. 6,163,732 disclose a system, method and computer program for determining compliance of chemical products to governmental regulations. The chemical composition present in the chemical product to be manufactured is ascertained and compared to a stored set of government regulatory standards related to the chemical composition so that compliance can be determined. The regulatory databases are maintained and updated. The chemical composition is determined from manufacturing bills of materials. In U.S. Pat. No. 6,097,995 to Tipton et al., a hazardous materials and waste reduction management system is disclosed. The chemical management system includes a chemical inventory control system allowing a user to manage chemicals from a central station, to allow for the tracking of individual chemical containers throughout its life and an international chemical compatibility system with a compliance/education design to create compliance/education files for any country in the world. The system includes international hazardous material compatibility data stored on a computer for multi-tier compliance/education design data for creating files in any foreign language. The compliance data for chemicals is printed onto labels as well as compliance data for related safety equipment. The data represents a comparison of sampled data from an item of safety equipment compared to a set of standard criteria for performance of the item.

Wiitala et al., U.S. Pat. No. 6,122,622 disclose a computer aided system for compliance with chemical control laws. The system comprises a means for storing compliance information for substances, based on substance control laws of different jurisdictions having varying requirements and means for processing and program instructions to determine the compliance status for a product, based on the compliance information. This system is limited to chemical control law compliance.

The volume of government and industry regulatory requirements for a company's plants, equipment and personnel is continuously growing, constantly changing, and difficult to track. None of the above-referenced patents discuss or resolve the problem of having to continuously update rules and regulations. Nor do any discuss or teach the importance of periodically reviewing a company or organization's compliance with all the rules, regulations and recommended procedures that emanate from the multitude of regulatory entities.

Definitions

Compliance requirements: rules and regulations emanating from one or more laws, statutory codes, federal, state and local government rules and regulations, permit requirements, required tasks, required actions associated with rules and regulations, standards, policies, procedures and guidelines of one or more regulatory authorities.

Evergreen: constantly current and up-to-date.

Facility Sites: land as well as structures and buildings located on the land

Perpetual auditing: method of systematically and routinely verifying compliance with identified compliance requirements.

Regulatory authorities: government legislatures, government agencies, industry associations, and company organizations.

Subject items: facility sites including land, structures and buildings on the land, assets at the facility sites, including equipment located at the facility sites, operational activities occurring at the sites and personnel that are subject to rules and regulations

### SUMMARY

This invention relates to an innovative regulatory compliance system for an organization or company to continuously track the multitude of rules and regulations emanating from state and federal agencies, industry standards, watchdog organizations and the organization's own polices and procedures to insure that the rules and regulations remain evergreen. The method and system perpetually monitor and report the organization's compliance with the updated rules and regulations so that a compliance system and perpetual audit manual is generated. The compliance system and manual can be available to authorized users online or in any electronic or hard copy format.

One preferred method for perpetual compliance auditing comprises providing a secured, interactive web-based system. Accessibility to the web-based system is limited to authorized users. Subject items, that is, items subject to rules and regulations emanating from various government and industry entities, can include facility sites, assets such as equipment located at the facility sites, operational activities occurring at the sites and even personnel that are subject to government regulations, OSHA for example. The facility site preferably includes land as well as structures and buildings located on the land. During the method of this invention, the subject items specifically applicable to an authorized user are identified. The regulatory compliance requirements that are applicable for substantially each identified subject item are then determined. These regulations are continuously updated to remain evergreen.

Compliance requirements reports based on the specific identified subject items and the continuously updated regulatory compliance requirements are provided to one or more persons responsible for compliance so that any responsible person can perpetually audit and determine if the company is in compliance with current rules and regulations. To ensure compliance by company personnel, repeated reminders, in the form of emails, telephone messages or faxes, are generated to one or more persons responsible for accomplishing compliance and to their supervisors until the compliance requirement is completed or no longer applicable.

Advantageously, the web-based system comprises a series of software programs to enable the user to identify a subject item, a gas compressor engine for example, and track substantially all government rules, regulations, industry standards and company polices and procedures affecting the engine to ascertain the required compliance, including any permits and tasks necessary to be in compliance and the due date for the permits and tasks. Preferably, the compliance rules and regulations are kept evergreen by updating the system using software designed to compare the existing system's rules and regulations with newly published compliance rules and regulations and continuously updating the system with the new version of the rules and regulations.

One preferred embodiment of the method for regulatory compliance of this invention comprises providing a system for facilitating compliance on a secured interactive web site that is accessible to multiple computers via network connectivity, a LAN (Local Area Network) system or WAN (Wide Area Network) system, for example.

The regulatory compliance data is preferably in the format of a summary of applicable compliance requirements data. Compliance requirements data that is potentially applicable is also included for each subject item. The compliance requirements data can emanate from one or more laws, statutory codes, government rules, regulations, permit requirements, required tasks, required actions associated with rules and regulations, standards, policies, procedures and guidelines of one or more regulatory authorities. The one or more regulatory authorities comprise government legislatures, government agencies, industry associations, and company organizations. Links to sites providing the full text of the rules and regulations are available along with the summaries.

The method of this preferred embodiment of the invention can further comprise the step of formatting the regulatory compliance data as a report listing a summary of the applicable compliance requirements for identified subject items and potentially applicable compliance requirements for identified subject items. The summary of regulatory compliance data preferably comprises required data selected from a group of required data comprising tasks for compliance, routine operational procedures required for compliance such as keeping oily rags in sealed containers or compliance with emission regulations. The summary also includes exemptions from requirements, timing information and compliance triggers necessary to fulfill regulatory compliance requirements for identified subject items. The compliance requirements summary report can also include reasons for applicability of the compliance data requirements for identified subject items and reasons the potentially applicable compliance requirements are not currently applicable.

In another aspect of this invention, the reports preferably comprise one or more site information reports, one or more equipment information reports, one or more inventory reports, one or more applicable site rules reports such as emission reports, one or more applicable equipment rules reports, one or more permit conditions reports, one or more potentially applicable site rules reports, one or more potentially applicable equipment rules reports, one or more task summary reports, one or more task compliance reports, one or more checklists, one or more compliance tables, one or more equipment query reports, one or more audit manuals and combinations thereof. Preferably, the audit manual comprises a company profile, the profile comprising a specific facility site, equipment and operational activities for the specific facility site and the regulatory compliance requirements related to the facility site, equipment and operational activities. The audit manual can also include the names and contact information for the person or persons responsible for achieving compliance.

In still a further aspect of this invention, a preferred method comprises the step of continuously updating the regulatory compliance requirements for the identified subject items listed in the audit manual so that the compliance requirements remain evergreen. The step of continuously updating the compliance requirements comprises updating the regulatory compliance data as well as the status of the facility site or sites, equipment and operational activities. Preferably, updating regulatory compliance requirements is substantially simultaneous to public notice of changes to the requirements. Advantageously, reminders are sent to a responsible person to update the compliance status of the facility site, equipment and operational activities. The updated compliance requirements are repeatedly provided to the responsible person and possibly copied to upper management, for carrying out compliance requirements until the requirement is completed or no longer applicable.

In another preferred embodiment for perpetual compliance auditing, links to full text of applicable and potentially applicable compliance requirements data for each subject item are provided. The compliance requirements data can emanate from one or more laws, statutory codes, government rules, regulations, permit requirements, required tasks, required actions associated with rules and regulations, standards, policies, procedures and guidelines of one or more regulatory authorities

Another preferred embodiment of this present invention comprises a regulatory compliance system that provides perpetual auditing. The compliance system can be a web-based system hosted by a server, the web-based system is accessible by one or more computers. A data structure is located on the server, the data structure comprising compliance data, a summary of compliance requirements, a profile of the user organization and subject items subject to compliance. One or more secured, interactive web pages are accessible to authorized users for enabling users to determine applicable compliance requirements and potentially applicable compliance requirements for subject items specific to their company or organization. The system also comprises means for notifying a responsible person or an authorized user about the applicable compliance requirements, the potentially applicable compliance requirements, the one or more tasks and the one or more required operating activities for specific subject items. In one aspect, the means for reminding one or more responsible persons is an automated email system. The subject items can comprise facility sites, equipment located at the facility sites and operational activities occurring on the sites, such as emissions, the facility sites, equipment and operational activities being subject to regulatory compliance. The facility site can comprise land, structures and buildings on the land and people located at the facility site.

Advantageously, one aspect of the perpetual compliance audit system is that the system further comprises hyperlinks to one or more regulatory databases, such as published government regulatory databases, that contain currently updated versions of the full text of compliance requirements, permits and required tasks so that a user can have access to the full text as well as a summary of the rule or regulation. The system uniquely comprises a means for perpetually auditing the specific subject items to determine updated status of subject items and compliance with requirements as well as means for reminding the responsible person to comply with updated compliance requirements. In one preferred system, the unique means for perpetually auditing comprises a software program for comparing the government regulatory database to the existing system's compliance requirements and determining the updates necessary for the compliance requirements. In another aspect of this system, the means for perpetually auditing the compliance of identified subject items with the applicable compliance requirements and potentially applicable compliance requirements is a perpetual audit manual, electronic or manual, generated according to the method of the invention.

Preferably, the regulatory compliance data comprises a summary of applicable and potentially applicable compliance requirements data for each subject item. The compliance requirements data emanates from one or more laws, statutory codes, federal, state and local government rules and regulations, permit requirements, required tasks, required actions associated with rules and regulations, standards, policies, procedures and guidelines of one or more regulatory authorities. The one or more regulatory authorities comprise government legislatures, government agencies, industry associations, and company organizations.

The summary of regulatory compliance data can further comprise required data selected from a group of required data comprising tasks for compliance, routine operational procedures required for compliance, exemptions from requirements, timing information and compliance triggers necessary to fulfill regulatory compliance requirements for identified subject items. The regulatory compliance data can be formatted as a report listing a summary of the applicable compliance requirements for identified subject items and potentially applicable compliance requirements for identified subject items. The compliance requirements summary report preferably includes reasons for applicability of the compliance data requirements for identified subject items and reasons for potential applicability of the compliance data requirements.

The system and method of this invention can be used by various organizations and companies that must comply with government regulations, such as environmental rules and regulations, or regulations emanating from OSHA or DOT. The system and method can also be used to comply with industry standards or recommended procedures such as those emanating from API or a company's own in-house policies. For example, the online perpetual compliance auditing system and method can be used for online environmental, safety and other compliance requirements for petrochemical plants, automobile manufacturers, auto repair shops, construction businesses, education facilities and any other commercial operations requiring compliance with regulatory authority requirements.

### BRIEF DESCRIPTION OF DRAWINGS

FIGS. 1-9 are print outs of reports according to one embodiment of the method and system of this invention.

### DETAILED DESCRIPTION OF THE PREFERRED EMBODIMENTS

The method and system of this invention relate to perpetual compliance auditing for an organization, industry or company that must comply with the multitude of rules and regulations emanating from state and federal agencies, industry standards, watchdog organizations and the organization's own polices and procedures so that the rules and regulations remain evergreen and the company remains aware of and in compliance with new and updated regulations. The volume of regulatory requirements for facility sites, equipment and personnel is continuously growing as well as difficult to track, thereby making it difficult and time consuming for an organization to remain in compliance. The method and system of this invention perpetually monitor and report the organization's compliance with those updated rules and regulations so that a perpetual audit manual is generated online or in any electronic or hard copy format.

Referring to the Figures, the method for perpetual compliance auditing provides a secured, interactive web-based system that facilitates maintaining compliance with a multitude of rules and regulations. Accessibility to the web site is limited to authorized users. Identification means such as passwords are required to access the web site. Authorized users can include an organization's personnel, vendors and service providers or even a government regulatory agent who is given access to facilitate government auditing of the organization's facility. In one aspect, the web-based system is accessible on the World Wide Web. One preferred embodiment of the method for regulatory compliance of this invention comprises providing a system for facilitating compliance on a secured interactive web site that is accessible to multiple computers via network connectivity, a LAN (Local Area Network) system or WAN (Wide Area Network) system, for example.

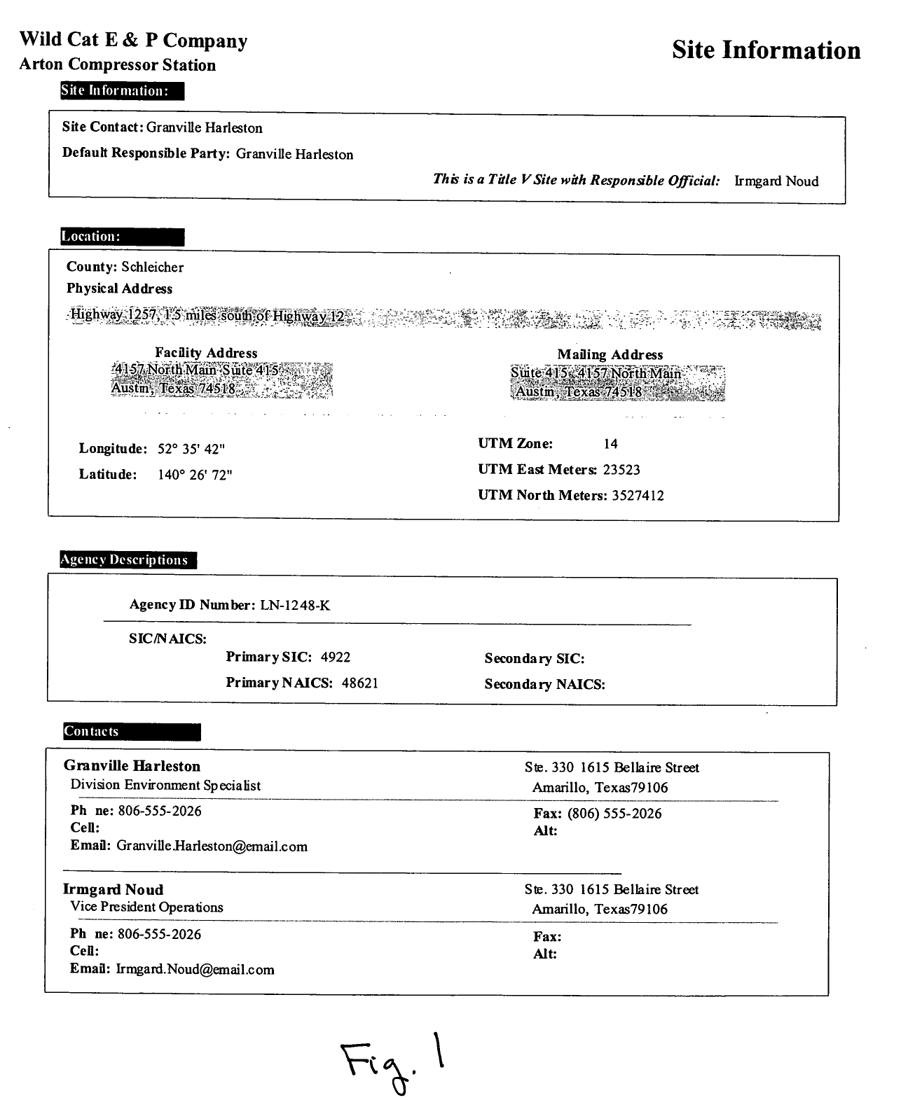

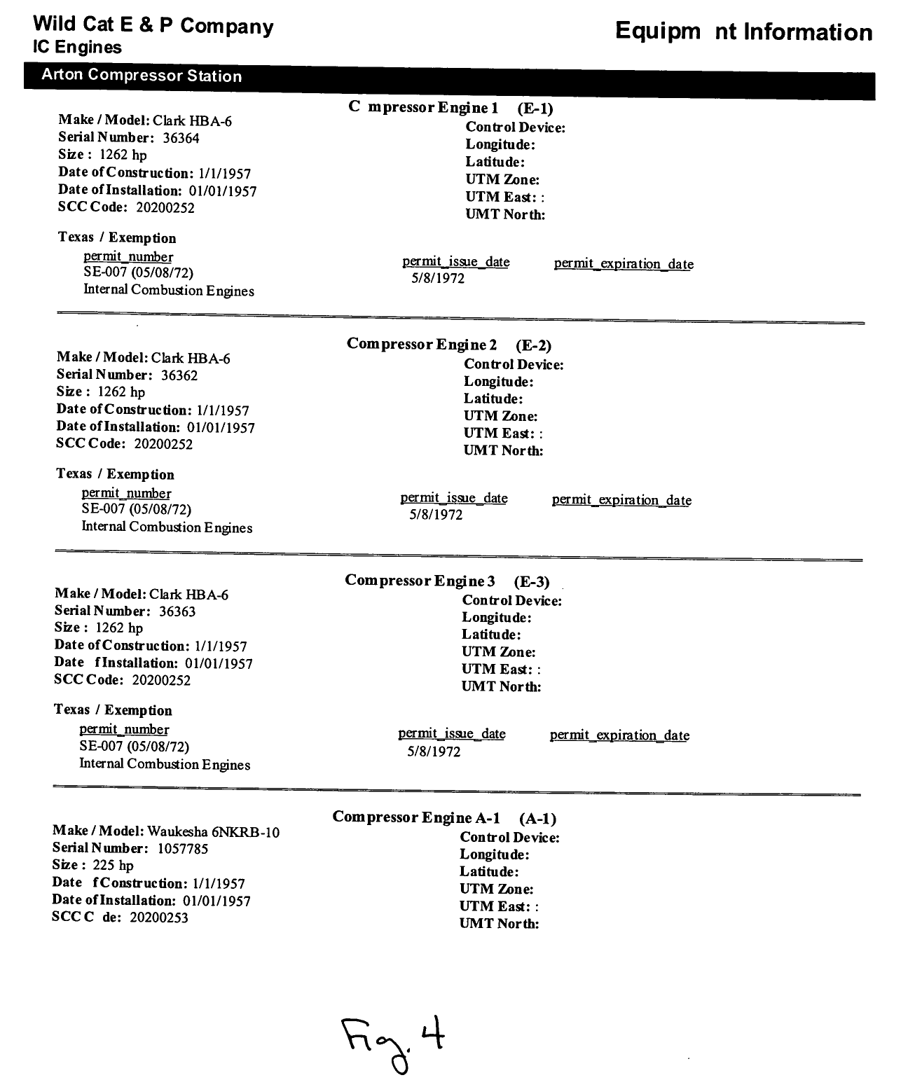

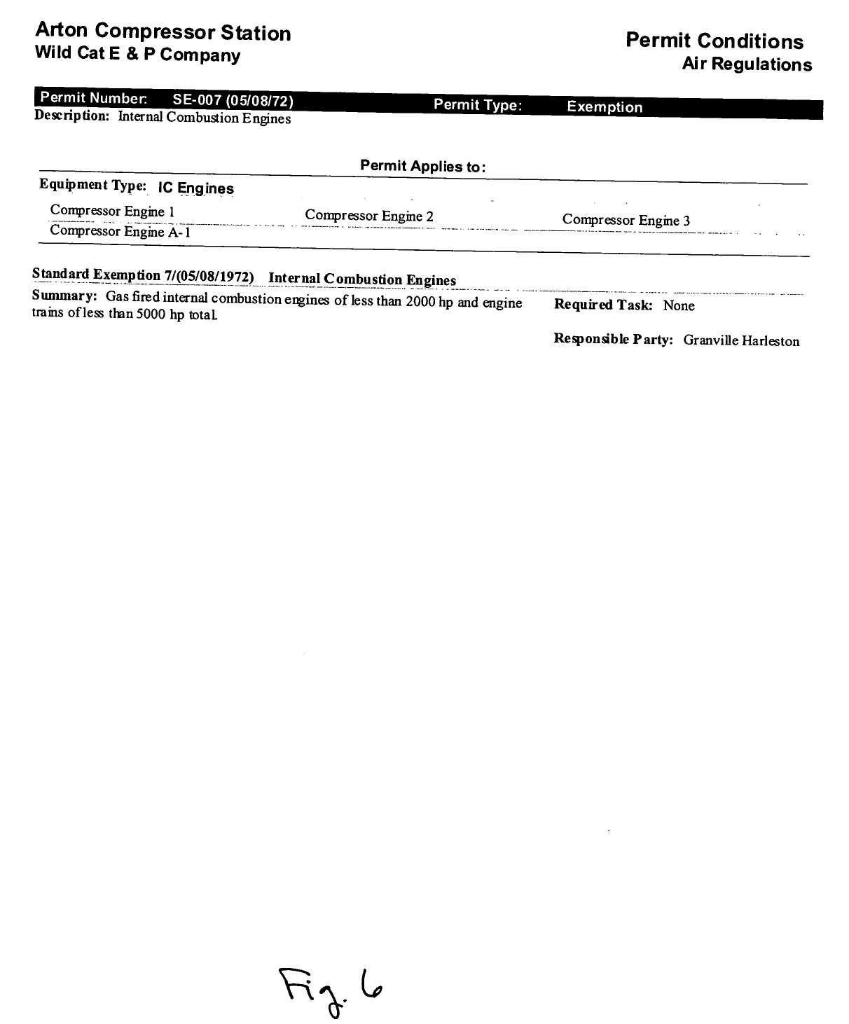

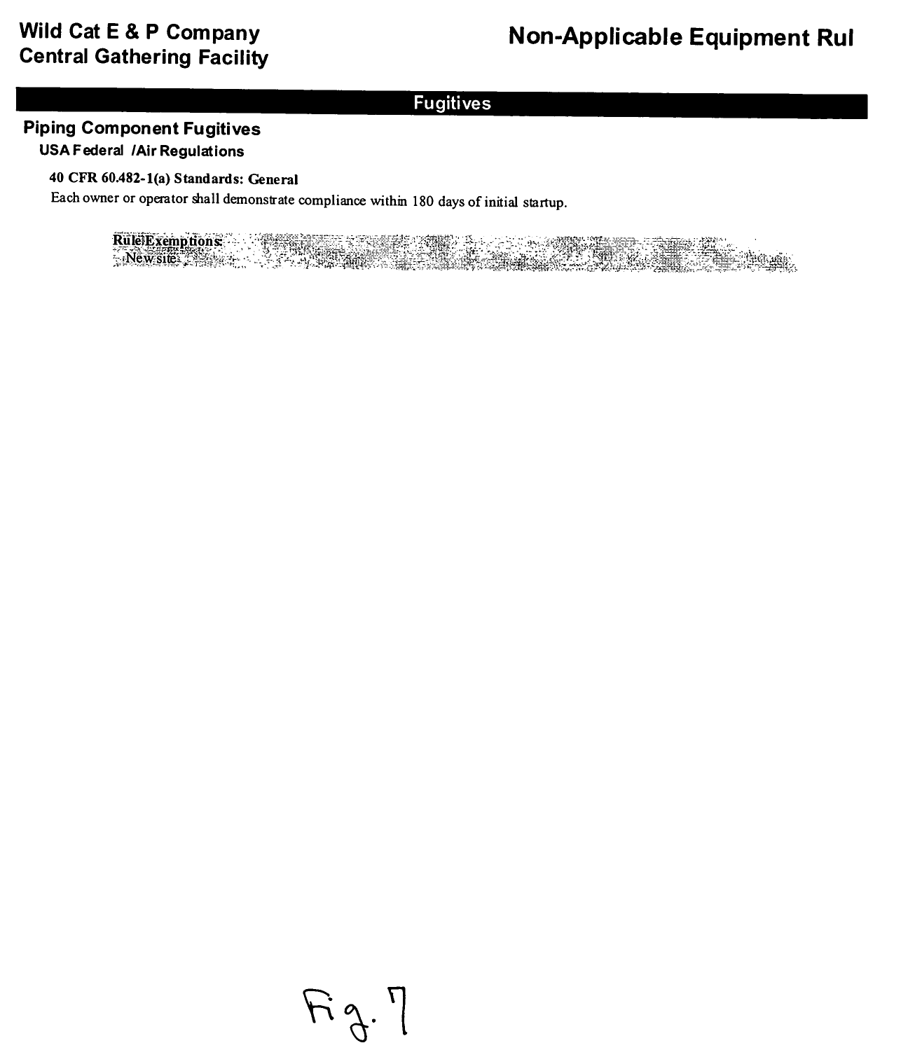

Once an authorized user is into the web site, she/he can open a screen listing the organization's companies and facility sites. The provider of the perpetual auditing method and system works with the organization to develop a profile of the organization and it's compliance needs. The web site is customized according to the profile. FIG. 1 is a web screen illustrating the information available once a site is selected. The figures are for illustrative purposes only and not limited to any particular industry or organization. The company profile delineates site location, agency descriptions and personnel who are responsible for compliance for that site. The subject items specific for that site locale are identified and selected by the user. Figure one illustrates typical site information and FIG. 4 lists equipment information, compressor engines in this embodiment. The data included for the equipment can vary depending on the organization's needs. In this illustration, pertinent information describing the compressors includes model number, identification number, size, date of construction, date of installation, SCC code number and permit information. FIG. 6 is a screen that can be accessed to show additional permit information for the subject items, compressor engines in this example. Important information regarding subject items that are exempt from permit requirements can also be included. Preferably, the method includes the step of formatting the regulatory compliance data as a summary of applicable compliance requirements for identified subject items and potentially applicable compliance requirements for identified subject items. Potentially applicable compliance requirements are those that may apply to the specific site or equipment but do not presently apply due to exemptions that can be claimed. For example, a tank may have a volume that is below the applicability threshold or a manufacturing facility may have a capacity that is less than the applicability threshold. In one aspect, the method can further include the step of reporting the reasons for applicability of compliance data requirements and reasons potentially applicable requirements are not currently applicable.

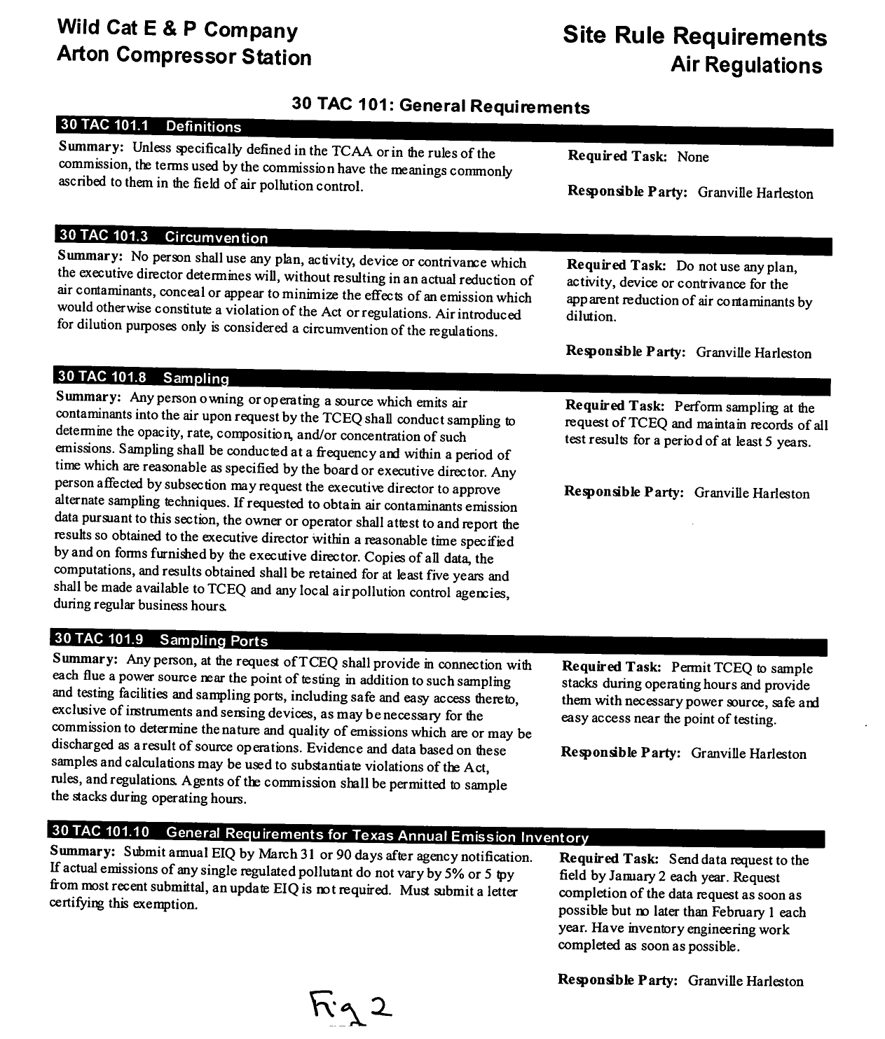

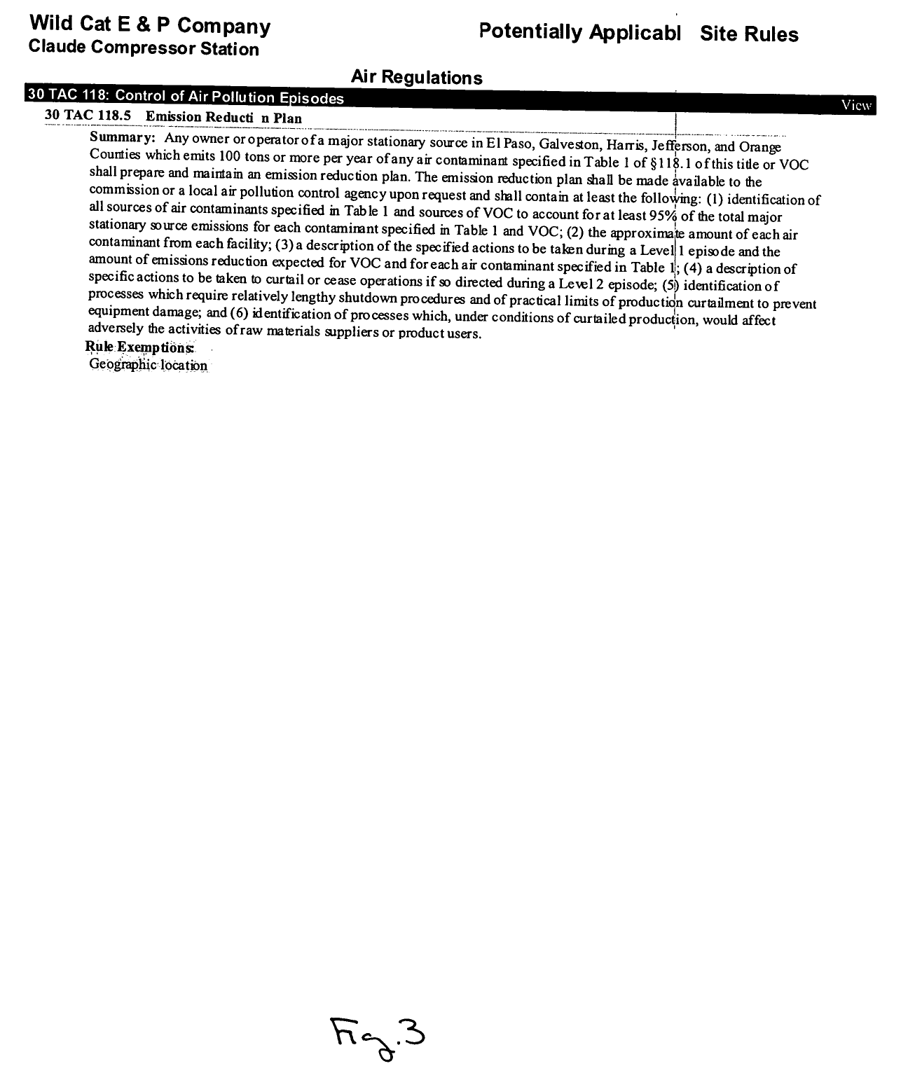

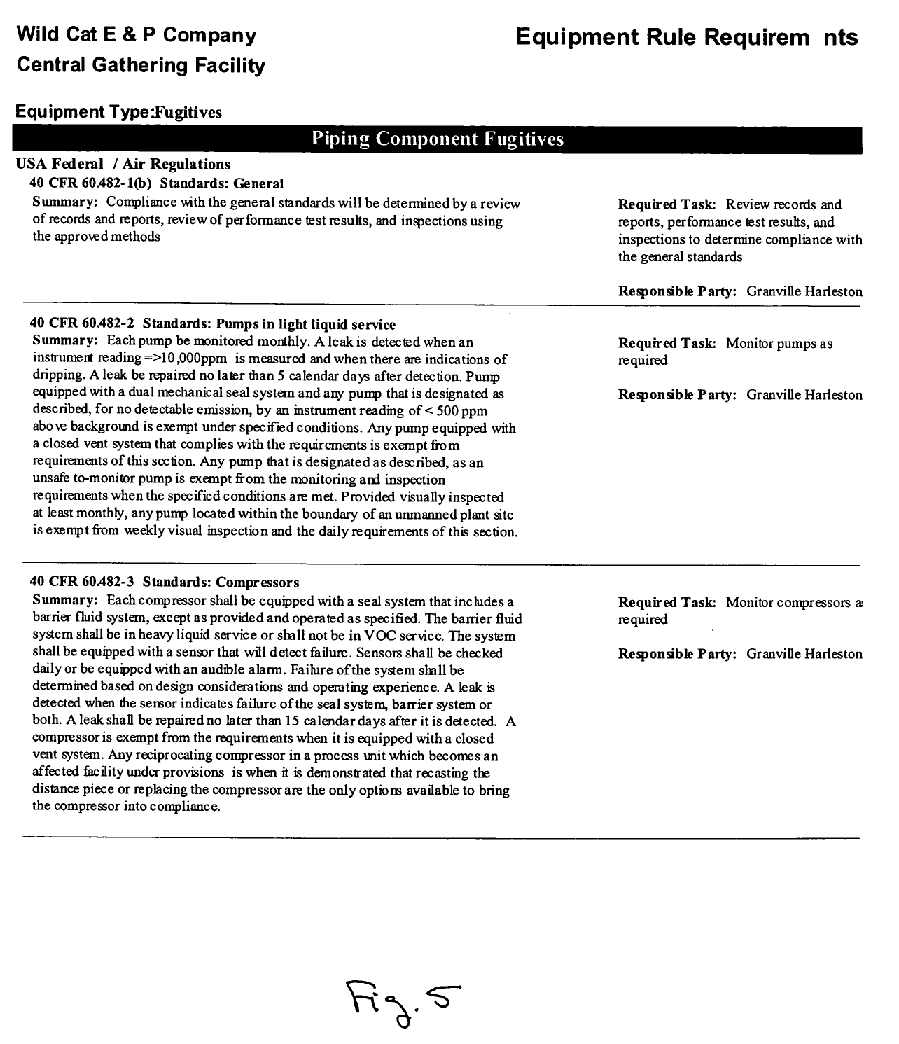

The method of this invention provides one or more software programs comprising databases located on the web-based system, the databases comprising subject items including facility sites, personnel, equipment, and operational activities subject to compliance. In this method, facility sites include site locales, buildings and structures located on the site locale. As illustrated by the Figures, the user then identifies the site locales, buildings, personnel, equipment, and operational activities, such as preventative maintenance activities that are not time defined, specific to a facility site belonging to the authorized user. The regulatory compliance requirements for substantially each identified site locale, building, personnel, piece of equipment, and operational activity are determined based upon regulatory compliance data and subject items provided in the one or more databases. FIG. 2 depicts several site rule requirements, in this case, air regulations, for a specific site locale. FIG. 5 depicts the rule requirements for a specific type of equipment, piping component fugitives.

Preferably one or more reports can be generated for tracking compliance with requirements as determined for each site locale, building, personnel, piece of equipment or operational activity identified. As illustrated by FIGS. 2 and 5, the reports can comprise a summary of compliance rules and regulations, tasks, permits, and required actions for each identified site locale, building, personnel group, equipment or operational activity. FIG. 2 is a partial list of air regulations affecting a specific site, a compressor station. It identifies the regulation, 30 TAC 101.1 for example, gives a summary of the regulation, required tasks, if any, and the person within the organization who is responsible for compliance. FIG. 5 is an example of a summary report for equipment. In one embodiment of this invention, hyperlinks are provided to sites that have the full text of the specific regulation, as seen in FIG. 5, clicking on the regulation, 40 CFR 60.482-1(b) will access the full text of the CFR rule. The reports can further include the timing for completion of tasks, permits, and required actions, if any, and a listing of one or more responsible persons for accomplishing compliance for the identified site locale, personnel, equipment or operational activity. Tasks are activities that are time defined and must be completed by a specific date.

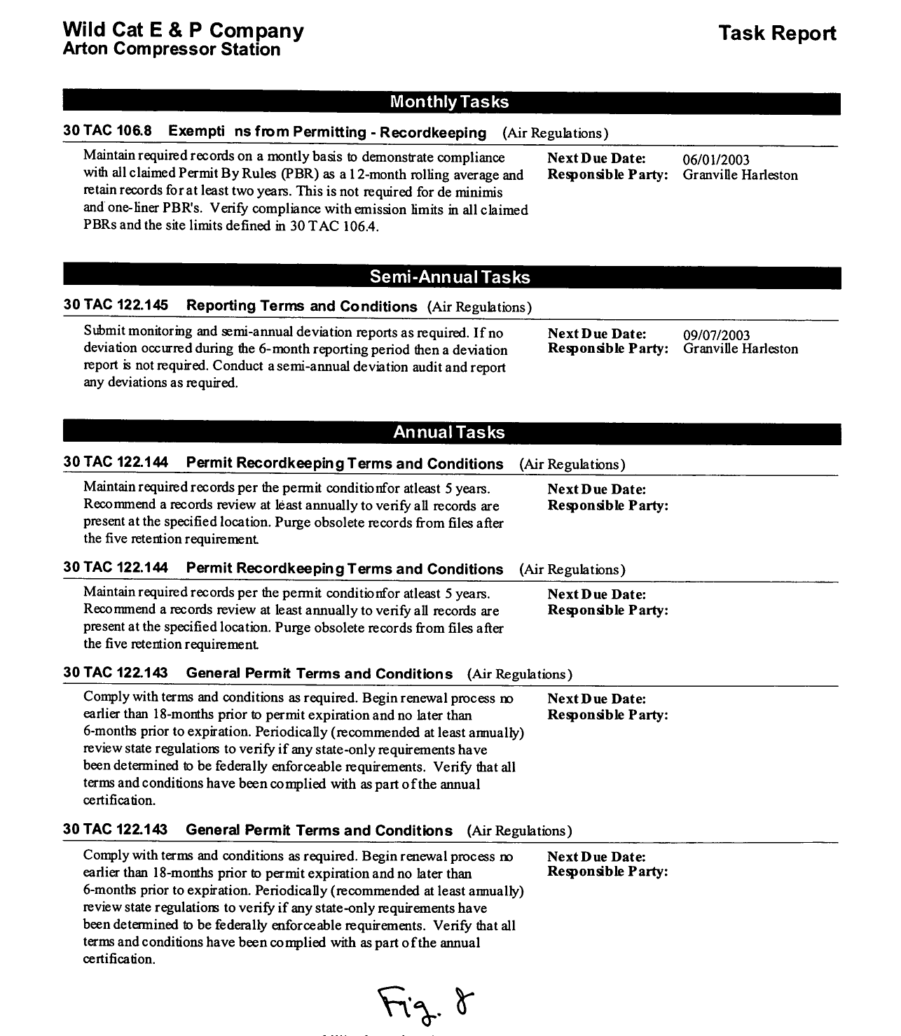

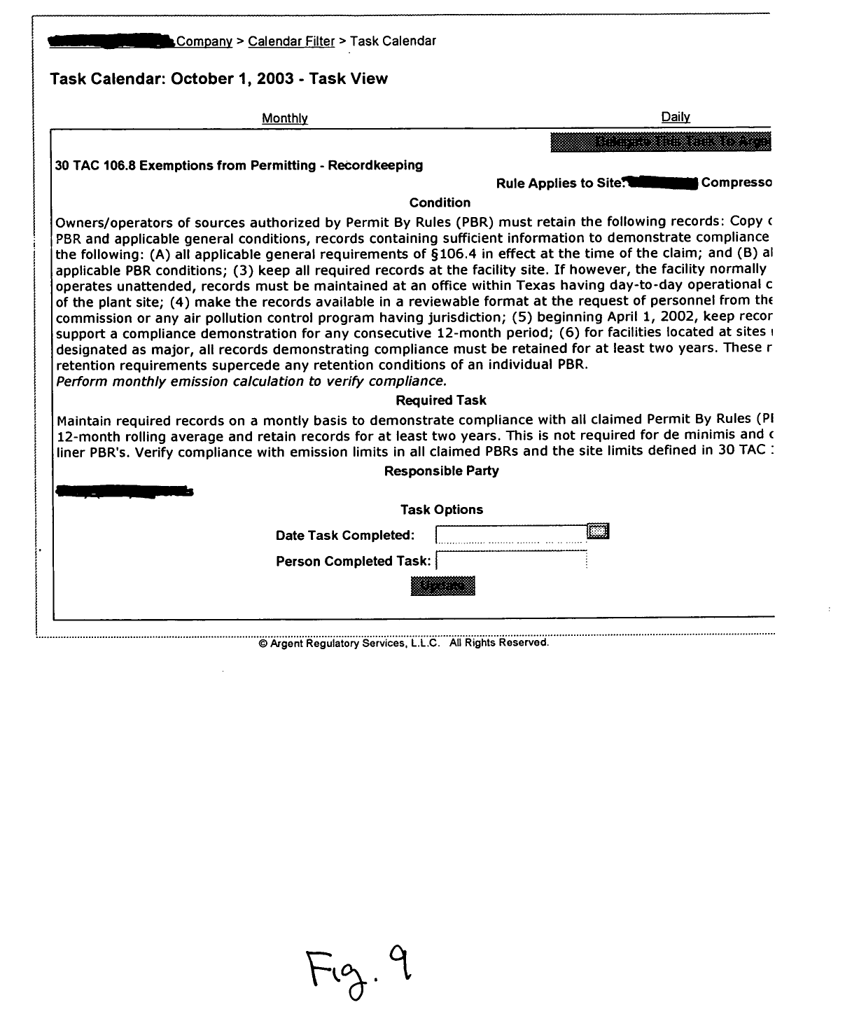

Operational activities can comprise routine operational procedures under compliance and compliance triggers. Storing oily rags in sealed containers is an example of a regulation that affects ongoing operational activity that must be monitored. Reports regarding compliance with this type of regulation can be sent to a responsible party at periodic intervals as reminders that this is a constant that must be continuously monitored. Preferably, one or more reports provide check lists for indicating when a compliance requirement is completed, or monitored if an ongoing operational activity, and the subject item is in compliance with rules. The user has the means to insert specific notes on the check list regarding compliance and can check a box to alert management if there is a compliance issue that must be addressed. FIG. 9 is a report illustrating a task calendar showing a summary of the rule, 30 TAC 106.8, how the rule applies, the required task to comply with the rule, the responsible party and the check list for the responsible party to sign off. Reports can be modified and designed to the needs of a specific organization. FIG. 8 is a task report for a particular site listing tasks that are required monthly, semi-annually and annually. A summary of the regulation, the due date for completion and the responsible party are included. These reports are accessible on the web site and notification of the updated regulation or rule is sent to the responsible party preferably as soon as the rule or regulation is updated. Reminders are sent periodically until the task is completed or no longer necessary such as when equipment is obsolete and not in use.

In one embodiment of the method for perpetual compliance auditing, the method can also comprise updating the one or more reports as the regulatory compliance requirement data is updated. Government regulations are frequently amended and new regulations written. Organizations must keep abreast with these changes. Also, new equipment may be added, existing equipment modified or old equipment removed. Changes also occur to operational activities. Under one preferred method of this invention, compliance requirement data and subject item data are continuously tracked by the compliance system provider and/or the responsible party and updated as the government or institutional regulations are changed. The tracking of compliance requirements ensures that the compliance system and audit manual are current. Because the compliance system comprises substantially all the rules and regulations in summary form, and these rules and regulations are perpetually updated, the user can easily audit compliance with current requirements, thereby maintaining an up-to-date audit manual. The updated data is provided to the responsible person until the requirement is completed or no longer applicable. This is one aspect in which the method and system of auditing a company's or organization's compliance is perpetual. Reminders can also be delivered to responsible persons up through the management chain until the recommended tasks for compliance are no longer applicable. In another aspect of this method, repeated reminders are sent to the one or more responsible persons regarding routine operational procedures for which compliance requirements are continuous. Maintaining the method of compliance auditing as a perpetual audit manual, available either online or as hard copies to interested parties, requires the step of sending reminders to one or more responsible persons to update the compliance status of the identified subject items as changes occur in the subject item and as regulatory compliance rules and regulations are updated by the various regulatory authorities.

In another aspect of the method of this invention, the system further comprises one or more interactive functions, the interactive functions can comprise a query, sort and find function for determining regulatory compliance data applicable to identified subject items, a continuous reminder function and a reporting function to generate reports and reminders for the one or more responsible persons.

Another preferred embodiment of the method for perpetual compliance auditing comprises providing a secured, interactive web-based system, and inputting regulatory compliance data and subject items into one or more relational databases or object oriented databases located within the system. Preferably, accessibility to the relational or object oriented databases is limited to authorized client users. One or more subject items that are applicable to a specific user are identified by means of a query, sort and find function. A computer data processor is used to determine compliance requirements, required tasks for compliance and compliance triggers necessary to fulfill compliance requirements for substantially each identified subject item. For example, a compliance trigger can comprise a due date for a specific task. During this step, the compliance rules and regulations, required tasks, and due dates as triggered are determined by the system of this invention and then transmitted to persons responsible for carrying out compliance. A report function is used to generate one or more reports. Preferably, a summary of compliance requirements, timing, exemptions, required tasks and triggers is provided to a responsible person for carrying out compliance tasks. The responsible person is repeatedly reminded of the compliance requirement data including specific actions required by specific compliance dates until the identified subject item is in compliance or the requirement is no longer applicable. The preferred method includes the step of repeatedly reminding the responsible person regarding compliance requirements for routine operations activities, personnel requirement to wear eye goggles when cutting pipe, for example.

In another aspect of this method, the compliance requirement data is provided to a responsible person according to preset time triggers. The preset time trigger can be set according to the occurrence of certain activities or events that occur specifically at a user site. The compiled reports can comprise a perpetual audit manual that satisfies requirements for an organization's internal auditing or even an outside auditor from a government regulatory agency. The perpetual audit manual is generated in an electronic format or provided as a hard copy. The compliance audit manual is generated for tracking compliance with the compliance requirements that were previously determined for the company profile of subject items. The audit manual can be customized for the user organization so that it comprises subject items identified by the user and a variety of reports and checklists. Reports can be formatted as one or more summaries of applicable compliance requirements for the specific facility site and substantially all of the assets and operational activities at the site. The audit manual also lists one or more responsible persons for accomplishing compliance for the identified subject items. The reports further comprise potentially applicable compliance requirements for the specific site and substantially all of the equipment and operational activities at the site locale. The reasons for applicability of compliance data requirements for the specific site locale and substantially all of the equipment and operational activities at the site locale are reported as well as the reasons potentially applicable requirements are not currently applicable. To remain perpetual, the audit manual and its compliance requirements reports are continuously updated with new regulatory compliance requirement data and updated subject item data.

Another preferred embodiment of this present invention comprises a regulatory compliance system for perpetually auditing compliance with regulatory requirements. The compliance system can be a web-based system hosted by a server that is accessible by one or more computers. A data structure is located on the server, the data structure comprises compliance data, a summary of compliance requirements and subject items subject to compliance. One or more secured, interactive web pages are accessible to authorized users for enabling users to determine applicable compliance requirements and potentially applicable compliance requirements for subject items specific to their company or organization. The system also comprises means for notifying a responsible person or an authorized user about the applicable compliance requirements, the potentially applicable compliance requirements, the one or more tasks and the one or more required operating activities for specific subject items. In one aspect, the means for reminding one or more responsible persons is an automated email system.

The subject items can comprise facility sites, equipment located at the facility sites and operational activities occurring on the sites, the facility sites, equipment and operational activities being subject to regulatory compliance. The facility site can comprise land, structures and buildings on the land and people located at the facility site.

Advantageously, one aspect of the perpetual compliance audit system is that the system further comprises hyperlinks to one or more regulatory databases, such as published government regulatory databases, that contain currently updated versions of the full text of compliance requirements, permits and required tasks so that a user can have access to the full text as well as a summary of the rule or regulation. The system uniquely comprises a means for perpetually auditing the specific subject items to determine updated status of subject items and compliance with requirements as well as means for reminding the responsible person to comply with updated compliance requirements. In one preferred system, the unique means for perpetually auditing comprises a software program for comparing the government regulatory database to the existing system's compliance requirements and determining the updates necessary for the compliance requirements. In another aspect of this system, the means for perpetually auditing the compliance of identified subject items with the applicable compliance requirements and potentially applicable compliance requirements is a perpetually updated audit manual generated according to the method of the invention.

Preferably, the regulatory compliance data comprises a summary of applicable and potentially applicable compliance requirements data for each subject item. The compliance requirements data emanates from one or more laws, statutory codes, federal, state and local government rules and regulations, permit requirements, required tasks, required actions associated with rules and regulations, standards, policies, procedures and guidelines of one or more regulatory authorities. The one or more regulatory authorities comprise government legislatures, government agencies, industry associations, the API for example, and company organizations.

The summary of regulatory compliance data can further comprise required data selected from a group of required data comprising tasks for compliance, routine operational procedures required for compliance, exemptions from requirements, timing information and compliance triggers necessary to fulfill regulatory compliance requirements for identified subject items. The regulatory compliance data can be formatted as a report listing a summary of the applicable compliance requirements for identified subject items and potentially applicable compliance requirements for identified subject items. The compliance requirements summary report preferably includes reasons for applicability of the compliance data requirements for identified subject items and reasons potentially applicable compliance requirements are not currently applicable. Using the example of a requirement that seals on a specific tank must be tested but the testing is not presently required, the reasons for a requirement that appears to be applicable but is not applicable at the present time could be that the tank was built prior to a deadline or that the volume capacity of the tank is below the trigger level. If the tank is changed or the requirement amended, this requirement can then become applicable.

The regulatory compliance system of the present invention is comprehensive as well as perpetual in that it compiles substantially all compliance rules and regulations for subject items within a facility site, the subject items including facility sites, equipment, materials and activities that may be regulated. Advantageously, the system comprises a series of software programs to enable the user to identify a subject item, a gas compressor engine for example, and track substantially all government rules, regulations, industry standards and company polices and procedures affecting the engine to ascertain the required compliance, including the required tasks necessary to be in compliance and the due date for the tasks. Preferably, the compliance rules and regulations are kept evergreen by continuous updating. Advantageously, each client company or user organization using this system can have a secured location on a web site that is accessible only to authorized persons and the web site can be customized for that organization. The web site can be a local area network site or on a World Wide Web site that is accessible to authorized users world wide from multiple computers. A system data preliminary check can be performed by the software to determine completeness of information and data entered. In the practice of this invention, an individualized, evergreen compliance system for each facility is developed and periodically updated according to new rules and regulations that may issue.

When an authorized user from a client company or organization accesses the web-based system, (s)he encounters a login page requiring authorization information such as a user name and password. Upon request for use of the compliance system, the interactive website software is programmed to initially authenticate the user by requesting and receiving authorization information such as client identification, passwords, or other means of identification from the requesting user. Sophisticated methods of securing access to the website, or means for authenticating, can be employed. Bodyscan coding, for example, is well known in the art. Bodyscan coding uses the client's eye, finger or hand prints to identify the service provider as an authorized user. One embodiment of the method and system of this invention is secured by using a combination of the operating system's built-in authentication methods and SQL server's database security. For distribution over the Internet, a Secure Sockets Layer (SSL) protocol can be used. A “Server Certificate” can be registered.

System Functions

One preferred embodiment of the system of this invention includes the following components:

| | |
|---|---|
| Administrative Data Entry | Equipment Report and Queries |
| Company Information | Identity of All Regulated |
| Site Information | Equipment |
| Client E-Mail Contacts | Includes Complete Description |
| Permit Information | Allows Management Queries |
| Regulatory Compliance Online | for Impact Analysis |
| Tables | |
| Complete Table Per Facility | Reporting |
| Applicable Rule Summary for Site | View All Information Online |
| and Individual Pieces of | Also Can Generate Hard |
| Equipment | |
| Recommended Compliance Task | Copies of All Reports and |
| Identity of Responsible person for | Queries |
| Compliance Task | Security |
| Identity of Compliance Triggers | Administrator Security |
| Compliance Reviews and | User Security |
| Certifications | Reporter Security |
| User Generated Checklist | EIS Manager Security |
| Quarterly Checklist Generated for | Management Security |
| Any Quarter | E-mail Notifications As Requested |
| Checklist Per Individual Facility | By User |
| and Equipment | Environmental Contacts |
| Provides Option for Completion | Individual Site Contacts |
| Verification Signature | Management Contacts |
| Useful for Compliance Reviews | |
| and Certifications | |

Applicable Uses of Regulatory Compliance System and Method

The regulatory compliance system and method of this invention can be adapted for use with the following:

Environmental On-Line Regulatory Service

DOT On-Line Regulatory Service

OSHA On-Line Requirement Service

Safety and Health On-Line Requirement Service

HAZMAT On-Line Training Modules

Environmental Regulatory On-LineTraining Modules

Emergency Incident Requirements Tables

MMS On Line Regulatory Reminder Service

Federal, State or Local Tax Regulatory Reminding Service

Environmental Management On-Line Training System

Mechanical Operation and Maintenance On-Line Tickler System

Environmental On-Line Interactive Training Modules

Education On-Line Interactive Training Modules

On Line Equipment Inventory Tracking and Reporting

On-Line Environmental Inspection Preparation Guidance

On Line OSHA Inspection Preparation Guidance

On Line Fleet Vehicle Requirements

On Line Management of Fleet Services-Environmental, Mechanical and Accounting Requirements

On Line Environmental Sampling and Testing Protocol Tables

On-Line Step by Step Up to Date Requirements and Options for CEMS—Continuous Emission Monitoring Systems

Biomedical Waste Management Compliance Service For Hospitals

On-Line Waste Handling Compliance Manual For Various Industries

BroadBand Industry Requirements On Line

Environmental Compliance For Education Facilities—On Line For schools, universities and research facilities

Environmental Compliance Service For Tall Buildings—Information and Reminders

Environmental Compliance Service For Small Businesses—What you need to know and what you need to do

On-Line Environmental Compliance Service For Paints Shops

On-Line Environmental and Safety Compliance Service For Auto Shops

On-Line Environmental and Safety Compliance Service for Construction Businesses

On-Line Regulatory Compliance for Airports

On-Line Environmental and Waste Management Requirements for Food Service Businesses

On-Line Regulatory Compliance Reminders for Printers

On-Line Regulatory Compliance Reminders for Dry Cleaners

On-line Regulatory Compliance Reminders for the Housing Industry.

Implementation of Regulatory Compliance System

In one preferred practice of this invention, the Applicant works with key client companies and organizations to identify and enter subject item information, facility sites, personnel, equipment and operational activities. Field Compliance Surveys may be utilized. Applicant can interview field contacts as necessary to collect additional site data. The Applicant questions office contacts to collect regulatory history, including copies of site and equipment permits or registrations. Applicant gathers all applicable regulations for state and federal compliance requirements for each site. Local regulations and company policies and procedures are included when applicable. Applicant assigns applicabilities and explains applicabilities and non-applicabilities where useful. The Applicant then requests identification of responsible persons for various compliance tasks. Applicant can request access to technical and regulatory company or organizational contacts for review and approval of compliance deadline ‘lead times’, regulatory interpretations, equipment data and the finished product.

In one preferred method and system of this invention, the Applicant consistently maintains and periodically updates the web site with regulatory information, agency information and any changes to compliance deadlines. Other changes to site or equipment data are made as necessary.

The foregoing description is illustrative and explanatory of preferred embodiments of the invention, and variations in the method, systems and other details will become apparent to those skilled in the art. It is intended that all such variations and modifications which fall within the scope or spirit of the appended claims be embraced thereby.

1. A method for perpetual compliance auditing comprising:
(a) providing a secured, interactive web-based system, accessibility to the web-based system limited to authorized users;
(b) identifying subject items specific for an authorized user;
(c) determining regulatory compliance requirements applicable for substantially each subject item identified in step (b);
(d) providing compliance requirements reports comprising specific subject items and their related regulatory compliance requirements to one or more persons responsible for compliance;
(e) generating repeated reminders to one or more persons responsible for accomplishing compliance until the compliance requirement is completed or no longer applicable.

2. The method of claim 1 wherein the web-based system is accessible on the World Wide Web.

3. The method of claim 1 wherein the subject items comprise facility sites, equipment located at the facility sites and operational activities occurring on the sites, the facility sites, equipment and operational activities being subject to regulatory compliance.

4. The method of claim 3 wherein the facility site comprises land, structures and buildings on the land, and personnel located at the facility site.

5. The method of claim 1 wherein regulatory compliance data comprises a summary of applicable and potentially applicable compliance requirements data for each subject item, the compliance requirements data emanating from one or more laws, statutory codes, government rules, regulations, permit requirements, required tasks, required actions associated with rules and regulations, standards, policies, procedures and guidelines of one or more regulatory authorities.

6. The method of claim 5 wherein the one or more regulatory authorities comprise government legislatures, government agencies, industry associations, and company organizations.

7. The method of claim 5 wherein the summary of regulatory compliance data further comprises required data selected from a group of required data comprising tasks for compliance, routine operational procedures necessary for compliance, exemptions from requirements, timing information and compliance triggers necessary to fulfill regulatory compliance requirements for identified subject items.

8. The method of claim 5 further comprising the step of formatting the regulatory compliance data as a report listing a summary of the applicable compliance requirements for identified subject items and potentially applicable compliance requirements for identified subject items.

9. The method of claim 8 wherein the compliance requirements summary report includes reasons for applicability of the compliance data requirements for identified subject items and reasons the potentially applicable compliance requirements are not currently applicable.

10. The method of claim 1 wherein the reports comprise one or more site information reports, one or more equipment information reports, one or more inventory reports, one or more applicable site rules reports, one or more applicable equipment rules reports, one or more permit conditions reports, one or more potentially applicable site rules reports, one or more potentially applicable equipment rules reports, one or more task summary reports, one or more task compliance reports, one or more checklists, one or more compliance tables, one or more equipment query reports, one or more audit manuals and combinations thereof.

11. The method of claim 11 wherein the audit manual comprises a company profile, the profile comprising a specific facility site, equipment and operational activities for the specific facility site and the regulatory compliance requirements related to the facility site, equipment and operational activities.

12. The method of claim 11 further comprising the step of continuously updating the regulatory compliance requirements for the identified subject items listed in the audit manual so that compliance requirement data is evergreen.

13. The method of claim 12 wherein the step of continuously updating the compliance requirements comprises updating the regulatory compliance data and status of the facility site, equipment and operational activities.

14. The method of claim 13 wherein reminders are sent to the responsible person to update the compliance status of the equipment and operational activities.

15. The method of claim 12 wherein the updated compliance requirements are repeatedly provided to the responsible person for carrying out compliance requirements until the requirement is completed or no longer applicable.

16. The method of claim 11 wherein the step of updating regulatory compliance requirements is substantially simultaneous to public notice of changes to the requirements.

17. The method of claim 1 further providing links to full text of applicable and potentially applicable compliance requirements data for each subject item, the compliance requirements data emanating from one or more laws, statutory codes, government rules, regulations, permit requirements, required tasks, required actions associated with rules and regulations, standards, policies, procedures and guidelines of one or more regulatory authorities.

18. A method for perpetual compliance auditing comprising:
(a) providing a secured, interactive web-based system, accessibility limited to authorized users;
(b) identifying subject items specific for an authorized user;
(c) providing one or more software programs comprising databases on the web-based system, the databases comprising subject items, the subject items comprising site locales, buildings, personnel, equipment and operational activities subject to compliance;
(d) identifying site locales, buildings, personnel, equipment, and operational activities specific to a facility site belonging to the authorized user;
(e) determining the regulatory compliance requirements for substantially each site locale, buildings, personnel, piece of equipment, or operational activity identified in step (d) based upon regulatory compliance data and subject items provided in the one or more databases;
(f) generating one or more reports for tracking compliance with requirements determined in step (e) for each site locale, buildings, personnel, piece of equipment or operational activity identified in step (d), the reports comprising a summary of compliance rules and regulations, tasks, permits, and required actions for the identified site locale, buildings, personnel, equipment or operational activity, the timing for completion of tasks, permits, and required actions, if any, and a listing of one or more responsible persons for accomplishing compliance for the identified site locale, equipment or operational activity.

19. The method of claim 18 wherein the required actions comprise routine operational procedures under compliance and compliance triggers.

20. The method of claim 18 wherein the one or more reports provides check lists for indicating when a compliance requirement is completed and the subject item is in compliance with rules.

21. The method of claim 18 further comprising updating the one or more reports with updated regulatory compliance requirement data and updated equipment and activity data.

22. The method of claim 18 wherein the updated compliance requirement data is repeatedly provided to a responsible person until the requirement is completed or no longer applicable.

23. The method of claim 18 further comprising the step of sending reminders to responsible persons up through the management chain until the recommended tasks for compliance are no longer applicable.

24. The method of claim 18 further comprising the step of sending repeated reminders to the one or more responsible persons regarding routine operational procedures for which compliance requirements are continuous.

25. The method of claim 18 further comprising the step of sending reminders to the one or more responsible persons to update the compliance status of the identified subject items.

26. The method of claim 18 further comprising one or more interactive functions, the interactive functions comprising a query, sort and find function for determining regulatory compliance data applicable to identified subject items, a continuous reminder function and a reporting function to generate reports and reminders for the one or more responsible persons.

27. A method for perpetual compliance auditing comprising:
(a) providing a secured, interactive web-based system;
(b) inputting regulatory compliance data and subject items into one or more databases, the databases selected from a group of databases comprising relational databases, object oriented databases and combinations thereof; accessibility to the databases limited to authorized client users;
(c) identifying one or more subject items input in step (b) that are applicable to a specific user with the use of a query, sort and find function;
(d) using a computer data processor, determining compliance requirements, required tasks for compliance and compliance triggers necessary to fulfill compliance requirements for substantially each identified subject item;
(e) using a report function to generate one or more reports;
(f) providing a summary of compliance requirements, timing, exemptions, required tasks and triggers to a responsible person for carrying out compliance tasks;
(g) repeatedly reminding the responsible person regarding compliance requirement data of specific actions required by specific compliance dates until the identified subject item is in compliance or the requirement is no longer applicable;
(h) repeatedly reminding the responsible person regarding compliance requirements for routine operations activities.

28. The method of claim 27 wherein the compliance requirement data is provided to a responsible person according to preset time triggers.

29. The method of claim 27 wherein reports comprise an audit manual.

30. The method of claim 27 further comprising the step of formatting the regulatory compliance data as a summary of applicable compliance requirements for identified subject items and potentially applicable compliance requirements for identified subject items.

31. The method of claim 30 further including the step of reporting the reasons for applicability of compliance data requirements and reasons why potentially applicable requirements are not currently applicable.

32. A method for generating a perpetual audit manual comprising:
(a) providing a secured, interactive web-based system, accessibility limited to authorized users;
(b) providing one or more software programs comprising a company profile of subject items, the subject items comprising one or more facility sites, equipment and operational activities related to the facility sites, the facility sites, equipment and operational activities subject to regulatory compliance, the software program further comprising regulatory compliance requirements for the one or more facility sites, equipment and operational activities;
(c) determining regulatory compliance requirements for substantially each specific facility site, equipment or operational activity identified in step (b);
(d) providing compliance requirements reports, the reports comprising one or more summaries of applicable compliance requirements for the specific facility site and substantially all of the equipment and operational activities at the site, the reports further comprising potentially applicable compliance requirements for the specific site and substantially all of the equipment and operational activities at the site locale;
(e) reporting the reasons for applicability of compliance data requirements for the specific site locale and substantially all of the equipment and operational activities at the site locale and reasons for potential applicability; and
(f) periodically updating compliance requirements reports with new regulatory compliance requirement data and updated subject item data;
(g) repeatedly reporting the updated regulatory compliance requirement data to one or more responsible persons for accomplishing compliance for the specific site locale and the equipment and operational activities at the specific site locale until the requirement is completed or no longer applicable;
(h) generating one or more check lists for task compliance and operating activities compliance based on steps (d) through (g).

33. The method of claim 32 wherein the check list comprises due date, completion date and person responsible for task compliance or operating activity compliance.

34. The method of claim 33 wherein one or more responsible persons are repeatedly reminded of the updated compliance requirement data and specific actions required for compliance according to the updated compliance requirements.

35. The method of claim 34 further comprising the step of continuously reminding one or more responsible persons regarding compliance requirements for routine operations tasks.

36. A method for perpetual compliance auditing comprising:
(a) providing a secured, interactive web site, accessibility to the one or more databases limited to authorized users;
(b) identifying specific subject items subject to regulatory compliance applicable for a specific user;
(c) determining regulatory compliance requirements for substantially each specific subject item identified in step (b);
(d) generating a compliance audit manual for tracking compliance with requirements determined in step (c) for subject items identified in step (b), the audit manual comprising identified subject items, a summary of compliance requirement data for identified subject items and a listing of one or more responsible persons for accomplishing compliance for the subject items;
(e) continuously updating audit manual with updated regulatory compliance requirement data and updated subject item data;
(f) reporting the reasons for applicability of compliance data requirements for specific subject items and reasons why potentially applicable requirements are not currently applicable; and
(g) perpetually reporting the updated regulatory compliance requirement data to the one or more responsible persons for accomplishing compliance for the subject items until requirement is no longer applicable.

37. The method of claim 36 further including the step of periodically providing new compliance requirement data for updated subject items to one or more responsible persons.

38. The method of claim 36 further including the step of periodically providing reminders to one or more responsible persons to update the status of subject items.

39. The method of claim 36 further comprising one or more check lists, the check list comprising a due date, a completion date and a person responsible for accomplishing compliance.

40. A compliance system comprising:
a web-based system hosted by a server, the web-based system accessible by multiple computers;
a data structure located on the server comprising compliance data, a summary of compliance requirements and subject items subject to compliance;
one or more secured, interactive web pages accessible to authorized users for enabling users to determine applicable compliance requirements and potentially applicable compliance requirements for specific subject items;
means for notifying a responsible person of an authorized user about the applicable compliance requirements, the potentially applicable compliance requirements, one or more tasks and one or more required operating activities for specific subject items;
hyperlinks to one or more regulatory databases comprising full text of compliance requirements, permits and required tasks;
means for perpetually auditing the compliance of specific subject items to determine updated status of subject items and compliance with requirements; and
means for reminding the responsible person to comply with updated compliance requirements.

41. A compliance system comprising:
a web-based system hosted by a server, the web-based system accessible by multiple computers;
a data structure on the server accessible through the web-based system, the data structure comprising subject items, regulatory compliance data, the regulatory compliance data comprising compliance requirements, a summary of compliance rules, operating activities requiring compliance and tasks required for compliance;
hyperlinks to one or more government regulatory databases comprising full text of compliance requirements;
a software program for comparing the compliance requirements to the government regulatory database for updating the compliance requirements;
means for perpetually auditing the compliance of specific subject items with the updated applicable compliance requirements and potentially applicable compliance requirements to determine updated status of subject items; and
means for reminding one or more responsible persons of the authorized user to comply with updated compliance requirements.

42. The compliance system of claim 41 wherein the means for reminding one or more responsible persons is an automated email system.

43. The compliance system of claim 41 wherein the means for perpetually auditing the compliance of subject items with the applicable compliance requirements and potentially applicable compliance requirements is a perpetual audit manual generated according to claim 32.

44. The compliance system of claim 41 wherein the subject items comprise facility sites, equipment located at the facility sites and operational activities occurring on the sites, the facility sites, equipment and operational activities being subject to regulatory compliance.

45. The compliance system of claim 41 wherein the facility site comprises land, structures and buildings on the land and people located at the facility site.

46. The compliance system of claim 41 wherein regulatory compliance data comprises a summary of applicable and potentially applicable compliance requirements data for each subject item, the compliance requirements data emanating from one or more laws, statutory codes, government rules, regulations, permit requirements, required tasks, required actions associated with rules and regulations, standards, policies, procedures and guidelines of one or more regulatory authorities.

47. The compliance system of claim 46 wherein the one or more regulatory authorities comprise government legislatures, government agencies, industry associations, and company organizations.

48. The compliance system of claim 46 wherein the summary of regulatory compliance data further comprises required data selected from a group of required data comprising tasks for compliance, routine operational procedures required for compliance, exemptions from requirements, timing information and compliance triggers necessary to fulfill regulatory compliance requirements for identified subject items.

49. The compliance system of claim 46 further comprising the step of formatting the regulatory compliance data as a report listing a summary of the applicable compliance requirements for identified subject items and potentially applicable compliance requirements for identified subject items.

50. The compliance system of claim 49 wherein the compliance requirements summary report includes reasons for applicability of the compliance data requirements for identified subject items and reasons why potentially applicable requirements are not currently applicable.
